(19) United States
(12) Patent Application Publication
(10) Pub. No.: US 2026/0135012 A1
(43) Pub. Date: May 14, 2026

(54) CHARGED PARTICLE TRAP

(71) Applicant: Oxford Ionics Limited, Begbroke (GB)

(72) Inventors: Maciej MALINOWSKI, Begbroke (GB); David ALLCOCK, Begbroke (GB); Thomas HARTY, Begbroke (GB); Chris BALLANCE, Begbroke (GB)

(73) Assignee: Oxford Ionics Limited, Begbroke (GB)

(21) Appl. No.: 19/109,988

(22) PCT Filed: Sep. 8, 2023
(86) PCT No.: PCT/GB2023/052324

§ 371 Date: Mar. 7, 2025

(30) Foreign Application Priority Data
Sep. 9, 2022 (GB) 2213239.3

(51) Int. Cl. G21K 1/20; G06N 10/40

(52) U.S. Cl. CPC G21K 1/20; G06N 10/40

(57) ABSTRACT

A charged particle trap is disclosed. The charged particle trap comprises a substrate and a layer structure disposed on the substrate, the layer structure including an antenna layer and an electrode layer. The antenna layer comprises a co-planar conductive meander line comprising at least three elongate arms which are parallel and co-planar, and which are symmetrical about a central axis. The electrode layer comprises a set of electrodes arranged to trap charged particles along a trap axis which is parallel to the central axis and to generate a pseudopotential which is symmetrical about the trap axis.

### FIELD

The present invention relates to a charged particle trap.

### BACKGROUND

A promising approach to trapped-ion quantum computing is to perform quantum gates without laser fields. In this arrangement, quantum gates are driven by strong magnetic field gradients. These gradients can be generated by passing currents through traces on an ion-trap chip.

An ideal setup for a multi-qubit quantum gate is to have very high magnetic-field gradients, while having substantially zero magnetic-field strength (herein referred to as “field-free gradient”). This is because, while the gradients are responsible for generating the desired coupling, the fields can generate undesired couplings, increasing the errors and/or reducing the effective interaction strength.

Two approaches have been used to generate field-free gradients.

C. Ospelkaus et al.: “Microwave quantum logic gates for trapped ion” https://arxiv.org/pdf/1104.3573.pdf (2011) describes a first approach in which multiple current lines are formed on a trap chip and respective phases and currents are adjusted to form the desired quadrupole. M. Wahnschaffe et al.: “Single-ion microwave near-field quantum sensor” https://arxiv.org/pdf/1601.06460.pdf (2021) describes a second approach in which a three-segment meander is formed on an upper surface of ion trap. The dimensions of the meander are simulated and the meander having those dimensions is then fabricated to produce a quadrupole at the ion location.

These approaches, however, have one or more drawbacks. The first approach requires multiple individually adjustable current sources, and low differential noise between separate conductors, which can be difficult to achieve. In the second approach, it can be challenging to align the magnetic field null with the ion location, for example, due to fabrication imperfections. In both cases, AC currents passing through the conductors generate AC electric fields which displace the ions, out of the magnetic null. Lastly, the design rules for current-carrying conductor design tend to conflict with those of the trap electrodes.

Proposals have been put forward to resolve conflicting requirements whereby the meander is provided by a multi-layer structure, entering the top layer only in a few areas close to the ions, and reference is made to H. Hahn et al.: “Multilayer ion trap with three-dimensional microwave circuitry for scalable quantum logic applications”, https://arxiv.org/pdf/1812.02445.pdf (2021). This, however, only partially mitigates the issue, as the top layer current-carrying electrodes still impose a significant design constraint on the trapping electrodes. Furthermore, the technology relies on high-current, layer-to-layer interconnects which are challenging to fabricate, for example, as shown in A. Bautista-Salvador et al.: “Multilayer ion trap technology for scalable quantum computing and quantum simulation”, New Journal of Physics, volume 21, 043011 (2019), and can introduce significant resistance unless afforded a large footprint.

GB 2 593 901 A describes an approach for partially nulling a magnetic field oriented in a direction that minimises its impact on a quantum gate. The partially-nulled field can still have an impact on a qubit, for example, in the form of fast frequency modulation, or dispersive qubit frequency shift.

### SUMMARY

According to a first aspect of the present invention there is provided a charged particle trap. The charged particle trap comprises a substrate, and a layer structure disposed on the substrate. The layer structure includes an antenna layer and an electrode layer. The antenna layer comprises a co-planar conductive meander line comprising at least three elongate arms which are parallel and co-planar, and which are symmetrical about a central axis. The electrode layer comprises a set of electrodes arranged to trap charged particles along a trap axis which is parallel to the central axis and to generate a pseudopotential which is symmetrical about the trap axis. For example, the pseudopotential may be symmetrical around the trap axis in an in-plane direction (that is, parallel to the electrode layer) perpendicular to the trap axis.

This arrangement can help to generate magnetic field gradients and to provide magnetic field cancellation where charged particles are to be trapped.

The antenna layer may be interposed between the substrate and the electrode layer. The antenna layer may lie above or below the electrode layer (in other words, be non-coplanar with the electrode layer).

The electrode layer is preferably symmetrical about the trap axis at least in a section along the trap axis in which charged particles are to be trapped.

The meander line may comprise an odd number of elongate arms and include a middle arm such that the central axis runs along the middle arm. The meander line may comprise an even number of elongate arms and include a middle pair of arms such that the central axis runs between the middle pair of arms.

The conductive meander line may have a width of between 5 and 500 μm. The conductive meander line may have a thickness t of between 0.3 μm and 2 μm. The conductive meander line may comprise a superconducting material.

The layer structure further may further comprise a conductive layer interposed between the antenna layer and the electrode layer. The conductive layer may provide a ground plane. The conductive layer may be sheet-like. The conductive layer may be formed of a metal, such as aluminium

The layer structure further may further comprise a conductive connection layer (for example comprising a set of traces or wires) interposed between the antenna layer and the electrode layer. The conductive connection layer may be formed of a metal, such as aluminium. The conductive connection layer may be used to route signals to surface electrodes. The layer structure further may further comprise at least one conductive via or at least two conductive vias connecting the conductive connection layer to at least one or at least two of electrodes in the electrode layer.

The conductive meander line may be arranged to run in a bundle of at least two adjacent parallel strands, and three or more bundles may be symmetrical about the centre line.

The set of electrodes may include a set of surface electrodes having a shielding effectiveness S=20 log₁₀ [B0′/B1′]≤20 dB or <1 dB where B0′ would be the magnetic field gradient at a charged particle when trapped by the charged particle trap in absence of the set of surface electrodes, and B1′ would be the magnetic field gradient at a charged particle when trapped by the charged particle trap in the presence of the set of surface electrodes.

The elongate arms are preferably straight, for example, in a region through which the elongate arms and the central axis run.

According to a second aspect of the present invention there is provided a quantum information processing system. The quantum information processing system comprises a charged particle trap and a control system. The charged particle trap comprises a substrate, and a layer structure disposed on the substrate. The layer structure includes an antenna layer and an electrode layer. The antenna layer is interposed between the substrate and the electrode layer. The antenna layer comprises at least three wires which are parallel and co-planar, and which are symmetrical about a central axis, and wherein the electrode layer comprises a set of electrodes arranged to trap charged particles along a trap axis which is parallel to the central axis. The control system is for controlling the charged particle trap, for applying biases to the set of electrodes for trapping at least one ion and for performing at least one quantum logic gate on the at least one charged particle. The control system is arranged to drive currents through the at least three wires such that each current has a respective phase and that the currents are symmetrically about the central axis.

This arrangement can help to generate magnetic field gradients and to provide magnetic field cancellation where charged particles are to be trapped without using a meander.

The control system may comprise at least two bias sources.

The control system may comprise N bias sources. Each of the N bias sources is arranged to drive a respective current with a respective phase through a respective wire or through a respective bundle of at least two adjacent parallel wires.

The control system may comprise first and second bias sources. The first bias source is arranged to drive a first current with a first phase through a first set of at least one wire or a first set of at least one bundle of at least two adjacent parallel wires, and the second bias source is arranged to drive a second current with a second phase through a first set of at least one wire or a first set of at least one bundle of at least two adjacent parallel wires.

The at least three wires may comprise an odd number of wires, wherein the odd number of wires includes a middle wire, and the central axis runs along the middle wire. The at least three wires may comprise an even number of wires, wherein the even number of wires includes a middle pair of wires, and the central axis runs between the middle pair of wires.

The wires may have a width of between 5 and 500 μm. The wires may have a thickness t of between 0.3 μm and 2 μm. The wires may comprise a superconducting material.

The layer structure further may further comprise a conductive layer interposed between the antenna layer and the electrode layer. The conductive layer may provide a ground plane. The conductive layer may be sheet-like. The conductive layer may be formed of a metal, such as aluminium

The layer structure further may further comprise a conductive connection layer (for example comprising a set of traces or wires) interposed between the antenna layer and the electrode layer. The conductive connection layer may be formed of a metal, such as aluminium. The conductive connection layer may be used to route signals to surface electrodes. The layer structure further may further comprise at least one conductive via or at least two conductive vias connecting the conductive connection layer to at least one or at least two of electrodes in the electrode layer.

The wires may be arranged to run in a bundle of at least two adjacent parallel wires, and three or more bundles may be symmetrical about the centre line.

The set of electrodes may include a set of surface electrodes having a shielding effectiveness S=20 log₁₀[B0′/B1′]≤20 dB or <1 dB where B0′ would be the magnetic field gradient at a charged particle when trapped by the charged particle trap in absence of the set of surface electrodes, and B1′ would be the magnetic field gradient at a charged particle when trapped by the charged particle trap in the presence of the set of surface electrodes.

The wires are preferably straight, for example, in a region through which the elongate arms and the central axis run.

According to a third aspect of the present invention there is provided a quantum information processing system comprising the charged particle trap of the first aspect and a control system for controlling the charged particle trap, for applying biases to the set of electrodes for trapping at least one ion and for performing at least one quantum logic gate on the at least one charged particle.

The control system may be configured to pass a current through the conductive meander line or the wires having a frequency less than or equal to 1 GHz.

According to a third aspect of the present invention there is provided a method of operating the charged particle trap of the first aspect or the quantum information processing system of the second or third aspects, the method comprising trapping at least one charged particle in the trap, each charged particle providing a respective qubit, preparing initial qubit state(s), and applying a sequence of one or more gates to the qubit(s). Applying the sequence of one or more gates to the qubit(s) includes driving current through the meander line or wires having a frequency less than or equal to 1 GHz.

The method may further comprises reading out qubit state(s).

The charged particles may be ions, such as calcium ions (such as ⁴⁰Ca⁺ or ⁴³Ca⁺). The charged particles may be atoms or molecules with net electric charge, or elementary charged particles, such as electrons or positrons.

### BRIEF DESCRIPTION OF THE DRAWINGS

Certain embodiments of the present invention will now be described, by way of example, with reference to the accompanying drawings, in which:

FIG. 1 is a schematic plan view of a first antenna structure comprising a wire for generating a magnetic field gradient;

FIG. 2 is a schematic plan view of a second antenna structure comprising a two-arm meander for generating a magnetic field gradient;

FIG. 3 is a schematic plan view of a third antenna structure comprising a three-arm meander structure for generating a magnetic field gradient;

FIG. 4 is a schematic plan view of a fourth antenna structure comprising a four-arm meander structure for generating a magnetic field gradient;

FIG. 5 illustrates plot of simulated magnetic fields and magnetic field gradients for the three-arm meander structure shown in FIG. 3;

FIG. 6 is a schematic view of a quantum information processing system comprising a surface-electrode trap and a control system;

FIG. 7 is a schematic orthographic view of a charged-particle trap which includes an antenna comprising a four-arm meander;

FIG. 8 is schematic plan view of the charged-particle trap shown in FIG. 7;

FIG. 9 is a plan view of an antenna layer of a charged-particle trap;

FIG. 10 is a plan view of an electrode layer of a charged-particle trap;

FIG. 11 is a schematic plan view of a fifth antenna comprising a multi-turn three-arm meander for generating a magnetic field gradient;

FIG. 12 is a schematic plan view of a sixth antenna comprising a multi-turn four-arm meander for generating a magnetic field gradient;

FIG. 13 is a schematic view of a single-source drive arrangement;

FIG. 14 is a schematic view of a first multiple-source drive arrangement;

FIG. 15 is a schematic view of a second multiple-source drive arrangement;

FIG. 16 is schematic plan view of a charged-particle trap having a surface antenna.

### DETAILED DESCRIPTION OF CERTAIN EMBODIMENTS

### Introduction

Antenna structures are herein described. The structures can be driven by a single or multiple sources. The structures can be arranged to aid alignment of the magnetic field null with trapped ions. The structures can be buried and so permit shielding of AC electric fields and allow greater freedom of top-layer design. The structures are planar and, thus, can obviate the need for low-resistance, low-footprint interconnects and so help simplify fabrication. Signals can be supplied to the structures, for example, through large interconnects placed away from the other structures, or wirebonds attached directly to the structure on the buried layer. Finally, the structures can be adapted to produce high gradients at low currents, thereby helping to reduce the overall power consumption.

### Structures for Generating Magnetic Field Gradients

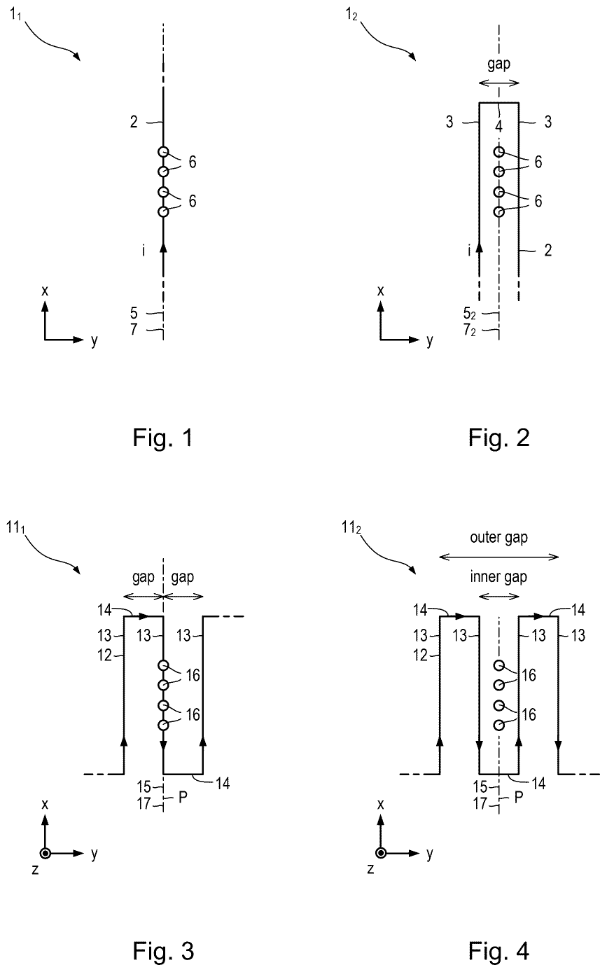

Referring to FIGS. 1 and 2, first and second antenna structures 11, 12 are shown.

The first antenna structure 11 takes the form of a single straight wire 2 running along a central axis 5 (in this case, parallel to the x-axis) through which a current, i, can be driven. The first antenna structure 11 can be used to apply a magnetic field gradient (not shown) to one or more charged particles 6 lying along an axis 7 which is parallel to and offset perpendicularly (along the z-axis) from the central axis 5.

The second antenna structure 12 takes the form of a meander wire structure 2 (herein also referred to as a “two-wire meander structure”, “two-arm meander structure”, “one-turn meander structure” or “single-segment meander structure”) having first and second elongate wire sections 3 (or “arms”) which are straight, parallel (in this case, parallel to the x-axis) and co-planar (in this case in the x-y plane), joined by a transverse section 4 (or “bridge”) and which are symmetrical about a central axis 5 (parallel to the x-axis). The second antenna structure 12 can be used to apply a magnetic field gradient (not shown) to one or more charged particles 6 lying along an axis 7 which is parallel to and offset perpendicularly (along the z-axis) from the central axis 5.

Although the first and second antenna structures 11, 12 can be used to generate magnetic field gradients (not shown), they are unable to provide a magnetic field cancellation, i.e., generate a region of null magnetic field, by themselves (e.g., without additional wires).

### Structures for Generating Magnetic Field Gradients and Magnetic Field Cancellation

Referring to FIGS. 3 and 4, third and fourth antenna structures 11₁, 11₂ are shown.

The third antenna structure 11₁ takes the form of a meander wire structure 12 (herein also referred to as a “three-wire meander structure”, “three-arm meander structure”, “two-turn meander structure” or “1.5-segment meander structure”) having first, second and third elongate wire sections 13 (or “arms”) which are straight, parallel and joined by first and second transverse sections 14 (or “bridges”) and which are symmetrical about a central axis 15. Thus, the wire 12 is boustrophedonic. The third antenna structure 11₁ can be used to apply a magnetic field gradient (not shown) to one or more charged particles 16 lying along an axis 17 which is parallel to and offset from the central axis 15 vertically (in this case, along the z-axis).

A charged-particle pseudopotential (not shown) is generated by electrodes which is symmetrical about the axis 17, in particular, is symmetric around the trap axis 17 in the in-plane direction y perpendicular to the trap axis, and about plane P which is perpendicular to the z-axis and in which the central and trap axes 15, 17 lie. Charged particles 16 may be trapped in chains, for example, two or more, for example for use in two-qubit gates.

The fourth antenna structure 11₂ takes the form of a meander wire structure 12 (herein also referred to as a “four-wire meander structure”, “four-arm meander structure”, “three-turn meander structure” or “two-segment meander structure”) having first, second, third and fourth elongate wire sections 13 which are straight, parallel and joined by first, second and third transverse sections 14, and which are symmetrical about a central axis 15. The fourth antenna structure 11₂ can be used to apply a magnetic field gradient (not shown) to one or more charged particles 16 lying along an axis 17 which is parallel to and offset vertically (in this case, along the z-axis) from the central axis 15.

A charged-particle pseudopotential (not shown) is generated by electrodes which is symmetrical about the axis 17, in particular, is symmetric around the trap axis 17 in an in-plane direction y perpendicular to the trap axis, plane P which is perpendicular to the z-axis and in which the central and trap axes 15, 17 lie. Charged particles 16 may be trapped in chains, for example, two or more, for example for use in two-qubit gates.

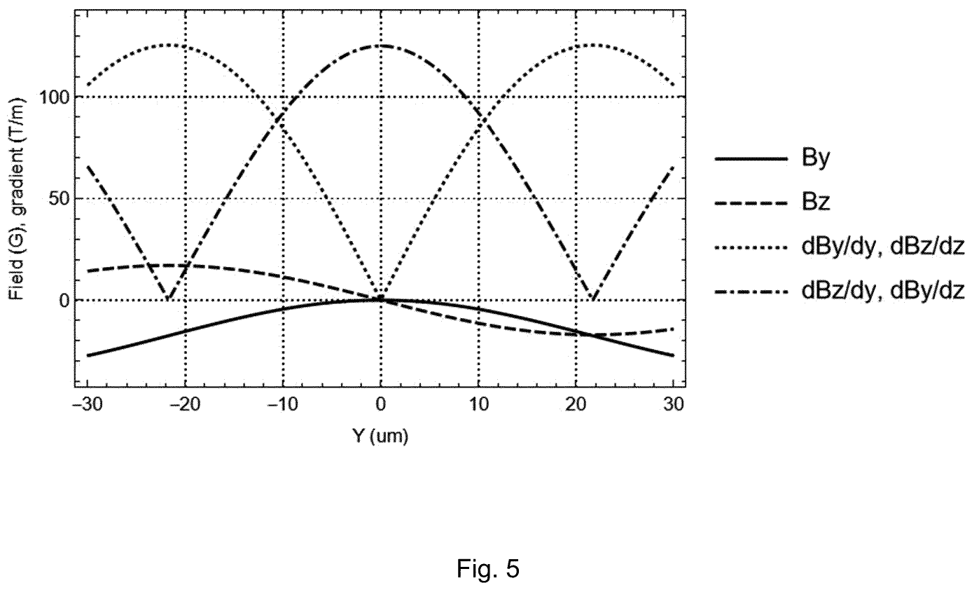

Referring to FIG. 5, plots of magnetic field along the y-axis (B_{y}), magnetic field along the z-axis (B_{z}), y- and z-magnetic field gradients along the y- and z-axes respectively (dB_{y}/dy, dB_{z}/dz) and z- and y-magnetic field gradients along the y- and z-axes (dB_{z}/dy, dB_{y}/dz) are shown for a three-wire meander at z=40 um (where z=0 is the plane of the meander), with a current of 1 A flowing through the meander.

At y=0, the magnetic field is nulled (B_{y}=B_{z}=0). At the same time, two gradient components (dB_{z}/dy and dB_{y}/dz) are not zero and, in fact, are strong, at 125 T/m.

By symmetry, B_{z}=0 is achieved. On the other hand, B_{y}=0 is only the case when the gap is chosen appropriately. In the simulation, it is assumed the traces are infinitely thin. In that case, the optimal gap is equal to the ion height (40 μm. In a real device, the optimal gap may be different due to finite trace width (as well as presence of nearby structures). Hence, a finer-grained simulation may be used to find the optimal gap for a real device.

### Quantum Information Processing System 21

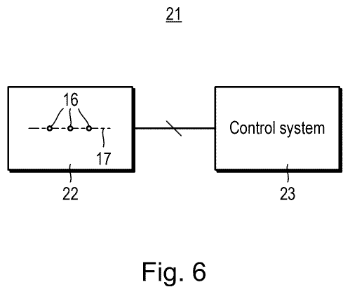

Referring to FIG. 6, a quantum information processing system 21 is shown which includes a surface-electrode trap 22 and a control system 23.

The surface-electrode trap 22 can be used to trap and control one or more charged particles 16 providing respective qubits along a trap axis 17.

The charged particle(s) 16 take the form of ion(s), such as calcium ions (⁴⁰Ca⁺), although they may, however, take the form of atom(s) or molecule(s) with net electric charge, or elementary charged particle(s), such as electrons or positrons.

The surface-electrode trap 22 may be housed in a cryogenic refrigerator (not shown) for cooling the surface-electrode trap 22 to a suitably low temperature T (e.g., below 77 K or 4.2 K). The surface-electrode trap 22 may operate at room temperature. The surface-electrode trap 22 may be housed in a vacuum chamber (not shown), which provides an ultra-high vacuum environment allowing individual charged particles to be isolated.

### Multi-Layer Charged Particle Trap

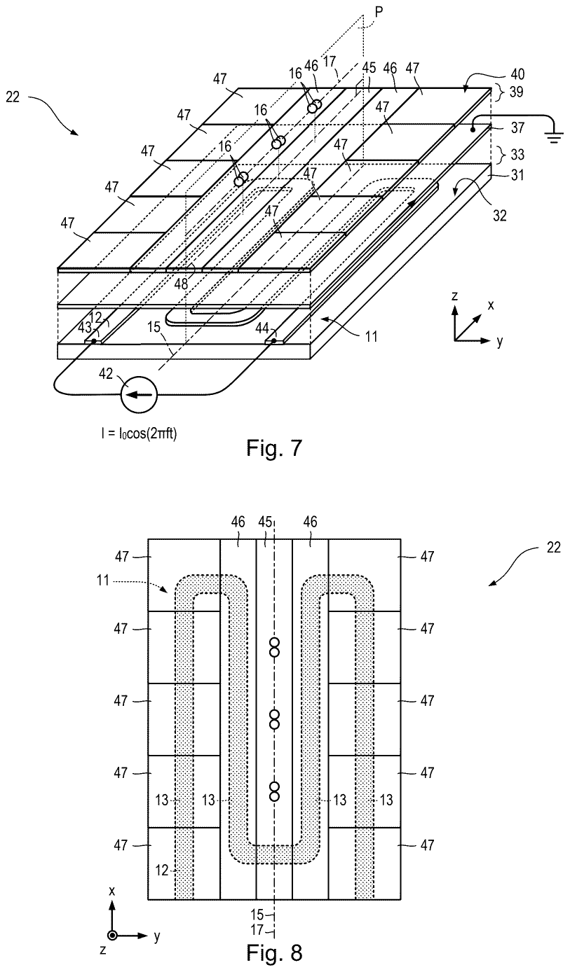

Referring to FIGS. 7 and 8, an example of a surface-electrode trap 22 is shown.

The surface-electrode trap 22 comprises a substrate 31, for example, comprising sapphire, having an upper surface 32 supporting an antenna layer 33, a first dielectric layer (not shown) comprising silicon dioxide and having an upper surface (not shown) supporting a conductive layer 37 comprising a conductive material, such a gold, aluminium or another suitable metal or degenerately-doped silicon or other suitable semiconductor layer, a second dielectric layer (not shown) comprising silicon dioxide and having an upper surface (not shown) supporting a charged particle trapping layer 39 having an upper surface 40 above which one or more charged particles 16 can be trapped. The conductive layer 37 may provide a ground plane. Additional layers (not shown) providing conductive tracks (not shown) can be provided, together with vias (not shown), to provide lines for signals to surface electrodes and wires. The antenna layer 33 and the charged particle trapping layer 39 are not co-planar and, in this case, the antenna layer 33 lies under the charged particle trapping layer 39.

The antenna layer 33 comprises an antenna structure 11 for generating magnetic field gradients and magnetic field cancellation, such as, for example, the third or fourth antenna structures 11₁ (FIG. 3), 11₂ (FIG. 4) hereinbefore described.

The antenna layer 33 comprises a co-planar conductive meander line 12 comprising at least three elongate arms 13 which are parallel and co-planar, and which are symmetrical about a central axis 15 which runs parallel to the trap axis 17. The central axis 15 and the trap axis 17 lie in a plane P which is perpendicular to the upper surface 40, and the trap axis 17 lies above the central axis 15.

The meander line 12 may be formed from a metal, such as gold, silver, or aluminium, a superconductor, such as rare-earth barium copper oxide, ReBCO, niobium or an alloy comprising niobium, or a semiconductor, such as doped silicon. The line 12 may have a width w (which is transverse to the current) of between 5 and 500 μm and may have a thickness t of between 0.3 μm and 20 μm.

The control system 23 includes a signal source 42 which is attached to first and second ends 43, 44 of the antenna structure 11.

The charged particle trapping layer 39 comprises an arrangement of electrodes 45, 46, 47 which can be used to trap and control one or more charged particles 16. In this case, charged particles 16 are shown trapped in pairs for use in two-qubit gates. Charged particles 16 may, however, be trapped singly or in longer chains of three or more particles 16.

The electrodes 45, 46, 47 include central electrode 45 takes the form of a strip running along a longitudinal axis 48 which parallel to the trap axis 17, and first and second electrodes 46 take the form of respective strips running either side along the central electrode 45 such that the central electrode 45 is interposed between the first and second electrodes 46. AC signals at RF frequencies are applied to the first and second electrodes 46 (herein also referred to as “first and second RF electrodes”) for producing ponderomotive confining potentials. The electrodes 45, 46, 47 generate a pseudopotential (not shown) which is symmetrical about the plane P. In particular, the pseudopotential (no shown) is symmetric around the trap axis 17 in the y-direction. Along the z-direction, the pseudopotential (not shown) is asymmetric

The control system 10 applies suitable DC and AC current and voltages biases to the electrodes 45, 46, 47 of the surface-electrode trap 22.

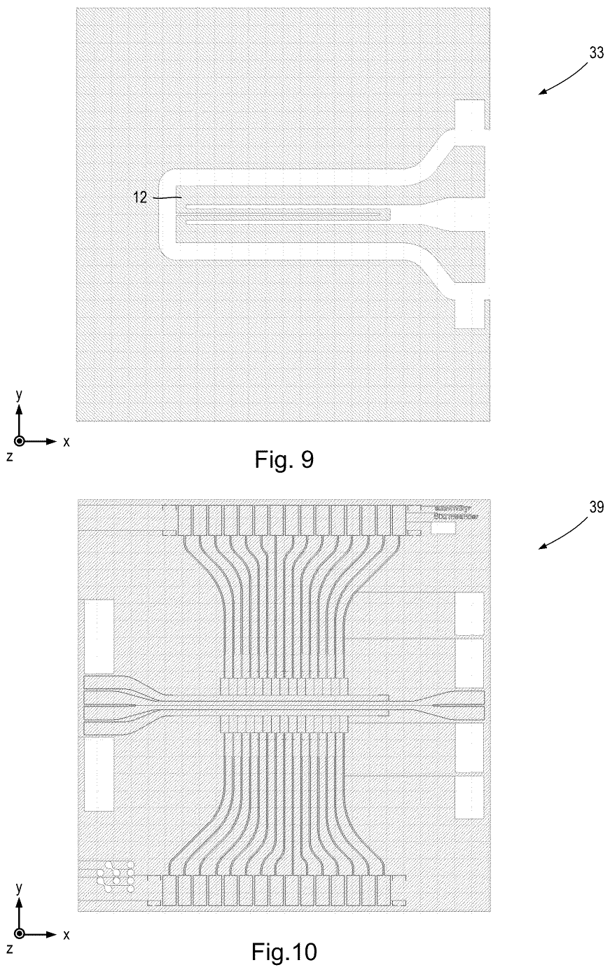

Referring to FIG. 9, the antenna layer 33 is shown.

Referring to FIG. 10, the charged particle trapping layer 39 is shown.

The meander line 12 is fully symmetric around y=0. This helps to provide cancellation of the magnetic field along one axis, namely, y or z, depending on design. In the 4-wire configuration shown in FIG. 10, the symmetry ensures field cancellation along y axis. Cancellation along the other axis (z in the case of the 4-wire design) can be arranged by judicious setting of conductor gaps and widths. Cancellation along the x-direction can be achieved by making the structure sufficiently long along x-direction.

The ability to make both the traps and the meanders symmetric significantly help in cancelling magnetic fields. The configuration can then become less sensitive to fabrication and simulation uncertainties.

The antenna layer 33 takes the form of a single, buried layer. This can lead to one or more advantages. The meander geometry can be adjusted for optimum performance, without constraining top electrode geometry. The trace width w can be increased compared thereby reducing resistance and, in turn, power consumption. Likewise, the trace thickness t can be increased without compromising the quality of fabrication of the top electrode The need for low-footprint, low-resistance vias can be avoided. This also makes the structure better suited to using superconducting traces since superconducting planar structures tend to be easier to fabricate than superconducting vias. The meander trace material can be freely selected for optimum performance, regardless of its impact on the ions, such as electric-field noise.

The layers above the antenna layer 33 provide a shielding structure. This can help to reduce the AC electric fields produced by the meander line 2 which can help ameliorate the issue of aligning the magnetic null with ion location. These electric fields can be further reduced by connecting the trace to the conductive plane 37 at a single point close to the charged particle 16 and driving it with a differential feed line.

To help ensure that sufficient magnetic gradients are generated, the frequency of the currents can be adjusted. Since lower-frequency magnetic fields are screened less, the structure is better suited for quantum gates generated by low-frequency gradients.

While thick, high-conductivity layers screen both electric and magnetic fields more effectively than thin, low-conductivity layers, electric fields are generally attenuated much more strongly than magnetic fields, at least at frequencies close to DC, for example, less than 100 Hz. Therefore, adjusting the geometry and conductivity of the shielding layers allows structures to be used which shield electric fields to a sufficient degree, while ensuring sufficient penetration of magnetic fields.

### Operation

The control system 23 passes a low-frequency (<1 GHz) current through the meander line 12. This can help to improve performance since passing higher frequencies through the line 12 can result in a field which is sensitive to induced currents, ground bounce, and phase shifts. Applying a low-frequency current helps to reduce currents in other layers, and minimise the wave phase shift across the antenna.

### Further Structures

Referring again to FIGS. 3 and 4, the third and fourth antenna structures 11₁, 11₂ comprising a single wire 12 which, in a single strand, turns back and forth to form the meander (herein referred to as “multi-turn, single-line meander”).

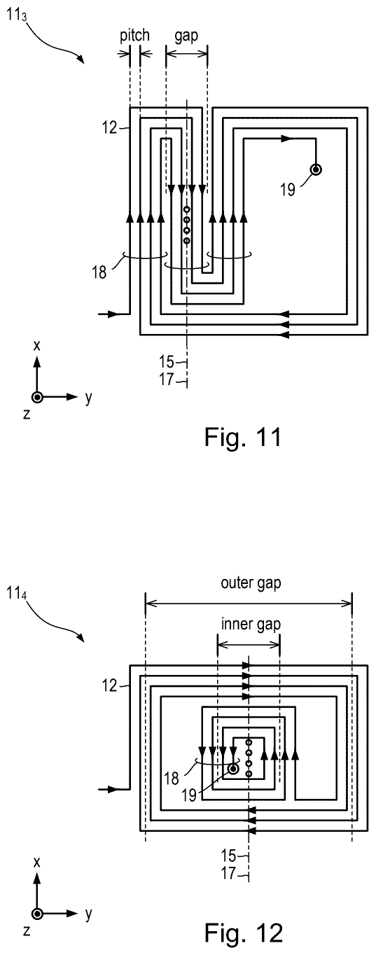

Referring to FIGS. 11 and 12, fifth and sixth antenna structures 113, 114 are shown which also comprise a single wire 12, which is arranged in three or more parallel strands, and the parallel strands turn in unison (e.g., in a pair, in a triplet or other multi-line bundle) back and forth, to form the meander (herein referred to as “multi-turn, multi-line meander”. Within each bundle there are straight, parallel strands.

In the fifth and sixth antenna structures 11₃, 11₄, the wires can be thinner than those in the third and fourth antenna structures 11₁, 11₂. This can help to reduce power consumption since one wire section of width w carrying a current I can be replaced with N parallel wire sections, each of width w/N and each carrying a current I/N to produce a comparable field gradient, while reducing power dissipation by a factor of N.

The fifth and sixth antenna structures 11₃, 11₄ are examples of multi-turn 3-wire meander and multi-turn 4-wire meander structures, respectively.

### Drive Arrangements

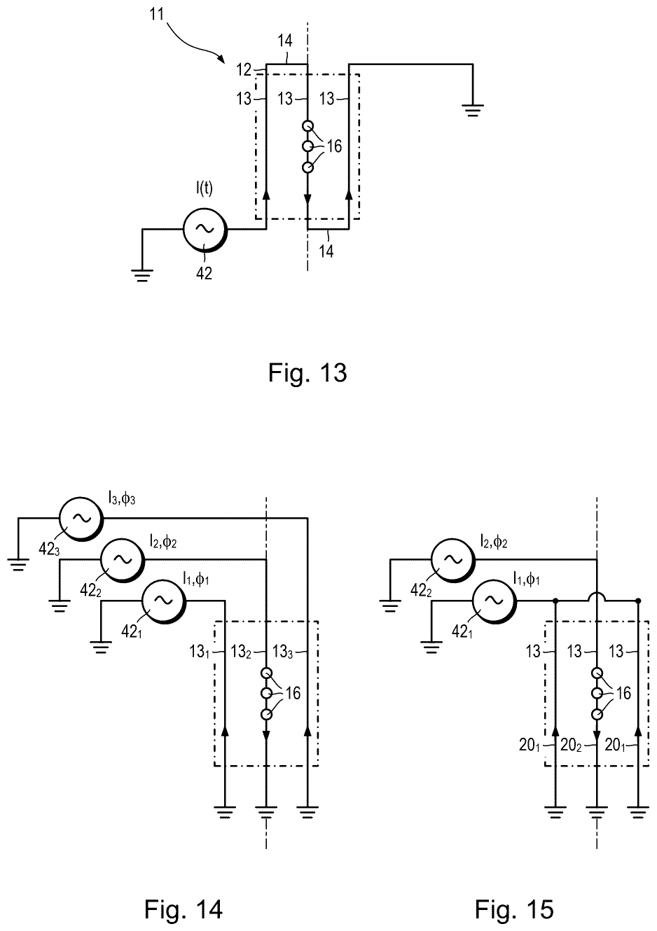

Referring to FIG. 13, a single source 42 can be used to drive a current I(t) through elongate wire sections 13 or a bundle 18 of strands (FIG. 11) which are connected in series. By virtue of the meander structure 12 which includes one or more bridges 14, the current in a given wire section 13 or a given bundle 18 of strands, and the current in the adjacent wire section(s) 13 or adjacent bundle(s) 18 of strands run anti-parallel, but have the same magnitude.

This arrangement, namely one which uses one source 42 to drive more than one elongate wire section 13 that are electrically connected in series, is herein referred to as a “passive arrangement”, “common source arrangement” or “series wire driving arrangement”.

This effect can, however, be achieved differently.

Referring to FIG. 14, plural sources 42₁, 42₂, 42₃ can be used whereby a source 42ᵢ drives a respective elongate wire 13₁, 13₂, 13₃ (or a respective bundle of strands), and the elongate wires 13 (or bundles) are not electrically connected in series. Instead, the current in one given wire, for example a second wire 13₂, is driven with a given phase φ, and the current in adjacent wire(s) (which in this case would be first and third wires 13₁, 13₃) are driven in anti-phase with the same magnitude.

This arrangement, namely one which uses N sources 42ᵢ (i=1, . . . , N) to drive to drive N elongate wires 13; or N bundles (i=1, . . . , N) which are not electrically connected in series, is herein referred to as an “active arrangement”, “separate source arrangement” or “parallel wire driving arrangement”.

Referring to FIG. 15, the same effect can be achieved using two sources 42 whereby a first source 42₁ drives a first set 201 of one or more alternate lines 13 or alternate bundles of strands in which the currents run parallel, and a second source 42₂ drives a second set 20₂ of one or more lines 13 or alternate bundles of strands in which the currents run anti-parallel relative to the first set.

This arrangement, namely one which uses two source 42 to drive N elongate wire 13 and in which wires in one set are connected in parallel and wires in another set are also connected in parallel but the two sets are not electrically connected, is referred to as an “semi-active arrangement”, “shared source arrangement” or “split, parallel wire driving arrangement”.

### Surface Electrodes Shielding

The surface-electrode traps hereinbefore described may include one or more antennas (not shown) disposed under the surface electrodes, in other words, interposed between the substrate and surface electrodes. An antenna may take the form of a current-carrying conductive track (or “wire”) which generates a magnetic field which can act on the trapped charged particles. A dielectric layer, such as silicon dioxide, having a thickness of, for example, between 1 μm and 10 μm, may be deposited over the antenna(s) so as to electrically isolate the antenna(s) and the surface electrodes, such that the dielectric layer is interposed between the antenna(s) and the surface electrodes.

Shielding effectiveness S in dB is defined as:

$$S = 20 {log}_{10} ( B {0}^{′} / B {1}^{′} ) \qquad ( 1 )$$

where B0′ is the magnetic field gradient at the charged particle in absence of the shielding structure, and B1′ is the magnetic field gradient at the charged particle in the presence of the shielding structure.

Shielding effectiveness can be divided into three regimes, namely:
“Low shielding”: S<1 dB (i.e., B1′>0.9 B0′)
“Intermediate shielding”: 20 dB≥S≥1 dB (i.e., 0.1 B0′≤B1′≤0.9 B0′)
“High shielding”: S>20 dB (i.e., B1′<0.1 B0′)

The surface electrodes are preferably arranged so as to not shield the charged particles from the antenna(s), in other words, to be low shielding. Intermediate shielding may, however, be acceptable.

Low shielding can be achieved by (a) choosing a suitable material for the electrodes and a thickness for the electrodes that is much smaller than the skin depth δ of the material (i.e., t<<δ) and (b) configuring the electrode layout to have, for example, slots and/or gaps.

Shielding effectiveness may be estimated by modelling the layer above the antenna as a solid ground plane of thickness t and electrical conductivity σ. For example, a layer of copper at room temperature having a thickness of 500 nm (t=500 nm and σ=5.96×10⁷ S/m) is considered to be a low shielding layer at frequency f=10 MHz since S<1 dB. A layer of copper with residual resistivity ratio RRR=100 at 4 Kelvin having a thickness of 5 μm (t=5 μm and σ=5.96×10⁷ S/m) is a high-shielding layer at a frequency f=300 MHz since S>20 dB.

Shielding effectiveness S is modified by electrode geometry, especially the presence of slots and cut-outs. Shielding effectiveness for a sheet without slots or cur-outs can, however, be used as approximate value.

### Surface Antenna

The surface-electrode traps hereinbefore described employ a buried antenna. The antenna may, however, be provided at the surface. This may be used, for example in cases in which surface electrodes provide too much shielding.

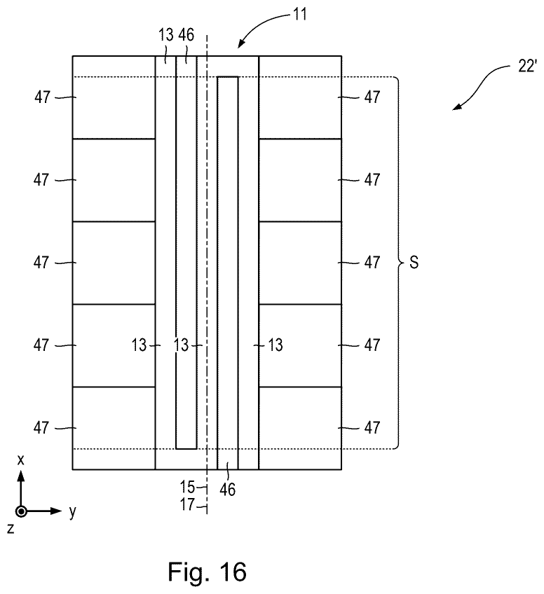

Referring to FIG. 16, another example of a surface-electrode trap 22′ is shown.

The surface-electrode trap 22′ is similar to the surface-electrode trap 22 (FIG. 8) described earlier. However, the antenna structure 11, in this case a three-arm structure, is formed on the upper surface. The antenna structure 11 comprises a conductive meander 12 comprising, in this case, three, straight arms 13 which are parallel and symmetrical about a central axis 15 which runs parallel to the trap axis 17.

Second electrodes 46 (or “RF electrodes”) are also provided on the upper surface between the arms 13. Third electrodes 47 (or “DC electrodes”) are disposed either side of the meander 12, either side of the trap axis 17.

The electrodes 46, 47 are arranged to generate a pseudopotential (not shown) for trapping charged particles which is symmetrical about the trap axis 17, along a central section S of the trap 22′. The pseudopotential (no shown) is symmetric around the trap axis 17 parallel to the layers along the y-direction.

### MODIFICATIONS

It will be appreciated that various modifications may be made to the embodiments hereinbefore described. Such modifications may involve equivalent and other features which are already known in the design, manufacture and use of charged particle traps and component parts thereof and which may be used instead of or in addition to features already described herein. Features of one embodiment may be replaced or supplemented by features of another embodiment.

The traps herein described have one layer of electrodes or two layers of electrodes (in which one of the layers of electrodes is buried). Traps with three or more layers (which include at least two buried layers of electrodes) may be used.

Although claims have been formulated in this application to particular combinations of features, it should be understood that the scope of the disclosure of the present invention also includes any novel features or any novel combination of features disclosed herein either explicitly or implicitly or any generalization thereof, whether or not it relates to the same invention as presently claimed in any claim and whether or not it mitigates any or all of the same technical problems as does the present invention. The applicants hereby give notice that new claims may be formulated to such features and/or combinations of such features during the prosecution of the present application or of any further application derived therefrom.

Wherefore, we claim:

1. A charged particle trap comprising:
a substrate; and
a layer structure disposed on the substrate, the layer structure including:
an antenna layer; and
an electrode layer,
wherein the antenna layer comprises a co-planar conductive meander line comprising at least three elongate arms which are parallel and co-planar, and which are symmetrical about a central axis, and wherein the electrode layer comprises a set of electrodes arranged to trap charged particles along a trap axis which is parallel to the central axis and to generate a pseudopotential which is symmetrical about the trap axis.

2. The charged particle trap of claim 1, wherein the antenna layer is interposed between the substrate and the electrode layer.

3. The charged particle trap of claim 1, wherein the meander line comprises an odd number of elongate arms, wherein the odd number of elongate arms includes a middle arm, and the central axis runs along the middle arm.

4. The charged particle trap of claim 1, wherein the meander line comprises an even number of elongate arms, wherein the even number of elongate arms includes a middle pair of arms, and the central axis runs between the middle pair of arms.

5. The charged particle trap of claim 1, wherein the conductive meander line has a width of between 5 and 500 μm.

6. The charged particle trap of claim 1, wherein the conductive meander line has a thickness t of between 0.3 μm and 2 μm.

7. The charged particle trap of claim 1, wherein the conductive meander line comprises a superconducting material.

8. The charged particle trap of claim 1, wherein the layer structure further comprises:
a conductive layer interposed between the antenna layer and the electrode layer.

9. The charged particle trap of claim 1, wherein the layer structure further comprises:
a conductive connection layer interposed between the antenna layer and the electrode layer.

10. The charged particle trap claim 1, wherein the conductive meander line is arranged to run in a bundle of two or more parallel strands, and wherein three or more bundles are symmetrical about the centre line.

11. The charged particle trap of claim 1, wherein the set of electrodes include a set of surface electrodes having a shielding effectiveness S=20 log₁₀[B0′/B1′]≤20 dB where B0′ would be the magnetic field gradient at a charged particle when trapped by the charged particle trap in absence of the set of surface electrodes, and B1′ would be the magnetic field gradient at a charged particle when trapped by the charged particle trap in the presence of the set of surface electrodes.

12. A quantum information processing system comprising:
a charged particle trap comprising:
a substrate; and
a layer structure disposed on the substrate, the layer structure including:
an antenna layer; and
an electrode layer,
wherein the antenna layer comprises at least three elongate arms which are parallel and co-planar, and which are symmetrical about a central axis, and wherein the electrode layer comprises a set of electrodes arranged to trap charged particles along a trap axis which is parallel to the central axis and to generate a pseudopotential which is symmetrical about the trap axis; and
a control system for controlling the charged particle trap, for applying biases to the set of electrodes for trapping at least one ion and for performing at least one quantum logic gate on the at least one charged particle,
wherein the control system is arranged to drive currents through the at least three elongate arms such that each current has a respective phase and that the currents are symmetrically about the central axis.

13. The quantum information processing system of claim 12, wherein the control system comprises at least two bias sources.

14. The quantum information processing system of claim 12, wherein the control system comprises:
N bias sources,
wherein each of the N bias sources is arranged to drive a respective current with a respective phase through a respective elongate arm or through a respective bundle of at least two adjacent parallel strands.

15. The quantum information processing system of claim 12, wherein the control system comprises:
first and second bias sources,
wherein the first bias source is arranged to drive a first current with a first phase through a first set of at least one arm or a first set of at least one bundle of at least two adjacent parallel strands, and the second bias source is arranged to drive a second current with a second phase through a first set of at least one arm or a first set of at least one bundle of at least two adjacent parallel strands.

16. A quantum information processing system comprising:
the charged particle trap of claim 1; and
a control system for controlling the charged particle trap, for applying biases to the set of electrodes for trapping at least one ion and for performing at least one quantum logic gate on the at least one charged particle.

17. The quantum control information processing system of any one or claim 12, wherein the control system is configured to pass a current through the conductive meander line having a frequency less than or equal to 1 GHz.

18. A method of operating the charged particle trap of claim 1, the method comprising:
trapping at least one charged particle in the trap, each charged particle providing a respective qubit;
preparing initial qubit state(s); and
applying a sequence of one or more gates to the qubit(s);
wherein applying the sequence of one or more gates to the qubit(s) includes driving current through the conductive meander line or wires having a frequency less than or equal to 1 GHz.

19. The method of claim 18, further comprising:
reading out qubit state(s).

20. A method of operating the quantum information processing system of claim 12, the method comprising:
trapping at least one charged particle in the trap, each charged particle providing a respective qubit;
preparing initial qubit state(s); and
applying a sequence of one or more gates to the qubit(s);
wherein applying the sequence of one or more gates to the qubit(s) includes driving current through the conductive meander line or wires having a frequency less than or equal to 1 GHz.

21. The method of claim 20, further comprising:
reading out qubit state(s).
